(19) United States
(12) Patent Application Publication
(10) Pub. No.: US 2026/0365253 A1
(43) Pub. Date: Nov. 19, 2026

(54) METHOD OF ASSEMBLING A VEHICLE INCLUDING BUMP FEATURES

(71) Applicant: Ford Global Technologies, LLC, Dearborn, MI (US)

(72) Inventors: Michael M. Azzouz, Farmington, MI (US); Vladimir Vladimirovich Bogachuk, West Bloomfield, MI (US); Conor Daniel Hennessey, South Hadley, MA (US)

(73) Assignee: Ford Global Technologies, LLC, Dearborn, MI (US)

(21) Appl. No.: 19/206,783

(22) Filed: May 13, 2025

(51) Int. Cl. B62D 27/00; B62D 25/04; B62D 65/06

(52) U.S. Cl. CPC B62D 27/00; B62D 25/04; B62D 65/06

(57) ABSTRACT

A method for assembling a vehicle that includes applying a first sealant material to a first part of a first vehicle structure and applying a second sealant material to a second part of the first vehicle structure, inserting a portion of the first vehicle structure into an opening of a second vehicle structure a first distance such that left and right pillars of the second vehicle structure move away from each other and are spaced part from respective first and second sealant materials, and inserting the portion of the first vehicle structure into the opening a second distance such that the left and right pillars move toward each other and contact the respective first and second sealant materials in a transverse direction.

### FIELD

The present disclosure relates to a method of assembling a vehicle including bump features.

### BACKGROUND

The statements in this section merely provide background information related to the present disclosure and may not constitute prior art.

Conventional vehicle assembly processes are typically linear processes that involves sequential build of a vehicle body structure referred to as Body-in-White, followed by painting the body structure, and then securing vehicle components such as a power train assembly, suspension assemblies, and an instrument panel assembly, for example, to a vehicle structure (e.g., uni-body structure) as the vehicle structure moves along an assembly line. Assembly of vehicle components to the vehicle structure may be slowed down due to restricted access to the vehicle structure at different points along the assembly line.

The present disclosure addresses these issues related to the access to the vehicle structure to secure vehicle components thereto as the vehicle structure moves along the assembly line.

### SUMMARY

This section provides a general summary of the disclosure and is not a comprehensive disclosure of its full scope or all of its features.

In one form, the present disclosure provides a method for assembling a vehicle. The method includes applying a first sealant material to a first part of a first vehicle structure and applying a second sealant material to a second part of the first vehicle structure, inserting a first portion of the first vehicle structure into an opening of a second vehicle structure a first distance such that opposing second portions of the second vehicle structure move away from each other and are spaced part from respective first and second sealant materials, and inserting the first portion of the first vehicle structure into the opening a second distance such that the opposing second portions move toward each other and contact the respective first and second sealant materials in a transverse direction.

In variations of the method of the above paragraph, which can be implemented individually or in any combination: one of the first and second vehicle structures includes left and right bump features that are configured to contact the other of the first and second vehicle structures to guide the opposing second portions of the second vehicle structure away from each other when the first portion of the first vehicle structure is inserted into the opening the first distance; the second vehicle structure includes the left and right bump features; the first sealant material is between the left bump feature and the first part of the first vehicle structure when the first portion of the first vehicle structure is inserted into the opening the second distance, and the second sealant material is between the right bump feature and the second part of the first vehicle structure when the first portion of the first vehicle structure is inserted into the opening the second distance; the opposing second portions are left and right pillars, the left bump feature is coupled to the left pillar and the right bump feature is coupled to the right pillar; the left bump feature is integrally formed with the left pillar and the right bump feature is integrally formed with the right pillar; the left bump feature extends inward from an inner surface of the left pillar and the right bump feature extends inward from an inner surface of the right pillar; the second vehicle structure includes a left flange and a right flange, and the first vehicle structure includes a left side and a right side; the left flange is located outboard the left side when the first portion of the first vehicle structure is inserted into the opening the first distance, and the right flange is located outboard the right side when the first portion of the first vehicle structure is inserted into the opening the first distance; the second vehicle structure defines a left door opening and a right door opening, and the left pillar partially defines the left door opening and the right pillar partially defines the right door opening; the first vehicle structure supports a motor and suspension components; and the first vehicle structure includes a pair of inner rails and a pair of cowl sides, each inner rail is arcuate and extends from a lower portion of a respective cowl side.

In another form, the present disclosure provides a method for assembling a vehicle. The method includes applying a first sealant material to a first part of a first vehicle structure and applying a second sealant material to a second part of the first vehicle structure, inserting a portion of the first vehicle structure into an opening of a second vehicle structure a first longitudinal distance such that left and right pillars of the second vehicle structure move away from each other and are spaced part from respective first and second sealant materials, and inserting the portion of the first vehicle structure into the opening a second longitudinal distance such that the left and right pillars move toward each other and contact the respective first and second sealant materials in a transverse direction. One of the first and second vehicle structures includes left and right bump features that are configured to contact the other of the first and second vehicle structures to move the left and right pillars of the second vehicle structure away from each other when the portion of the first vehicle structure is inserted into the opening the first longitudinal distance. The second vehicle structure defines a left door opening and a right door opening. The left pillar partially defines the left door opening and the right pillar partially defines the right door opening.

In variations of the method of the above paragraph, which can be implemented individually or in any combination: the second vehicle structure includes the left and right bump features; the first sealant material is between the left bump feature and the first part of the first vehicle structure when the portion of the first vehicle structure is inserted into the opening the second longitudinal distance, the second sealant material is between the right bump feature and the second part of the first vehicle structure when the portion of the first vehicle structure is inserted into the opening the second longitudinal distance; the left bump feature is coupled to the left pillar and the right bump feature is coupled to the right pillar; the left bump feature is integrally formed with the left pillar and the right bump feature is integrally formed with the right pillar; the left bump feature extends inward from an inner surface of the left pillar and the right bump feature extends inward from an inner surface of the right pillar; the second vehicle structure includes a left flange and a right flange, the first vehicle structure includes a left side and a right side; and the left flange is located outboard the left side when the portion of the first vehicle structure is inserted into the opening the first longitudinal distance, and the right flange is located outboard the right side when the portion of the first vehicle structure is inserted into the opening the first longitudinal distance.

In another form, the present disclosure provides a vehicle that includes a first vehicle structure, a second vehicle structure, and first and second sealant material. The second vehicle structure is configured to be coupled to the first vehicle structure. The second vehicle structure includes a left pillar and a right pillar. The first sealant material is applied to a first part of the first vehicle structure. The second sealant material is applied to a second part of the first vehicle structure. One of the first and second vehicle structures includes left and right bump features that are configured to contact the other of the first and second vehicle structures to guide the left pillar and the right pillar of the second vehicle structure away from each other when a portion of the first vehicle structure is inserted into an opening of the second vehicle structure a first distance. The left and right bump features are configured to move toward each other and contact respective first and second sealant materials in a transverse direction when the portion of the first vehicle structure is inserted into the opening a second distance.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a portion of a vehicle including a front vehicle structure and a rear vehicle structure according to the principles of the present disclosure;

FIG. 2 is another perspective view of the portion of the vehicle of FIG. 1 with body panels removed for clarity;

FIG. 3 is a portion of the rear vehicle structure of FIG. 1;

FIG. 4 is a perspective view of a portion of the front vehicle structure including sealant;

FIGS. 5A-5D are cross-sectional views showing the front vehicle structure and the rear vehicle structure being assembled;

FIGS. 6A-6C are bottoms views showing the front vehicle structure and the rear vehicle structure being assembled; and

FIG. 7 is a flow chart depicting a method for assembling the vehicle of FIG. 1.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

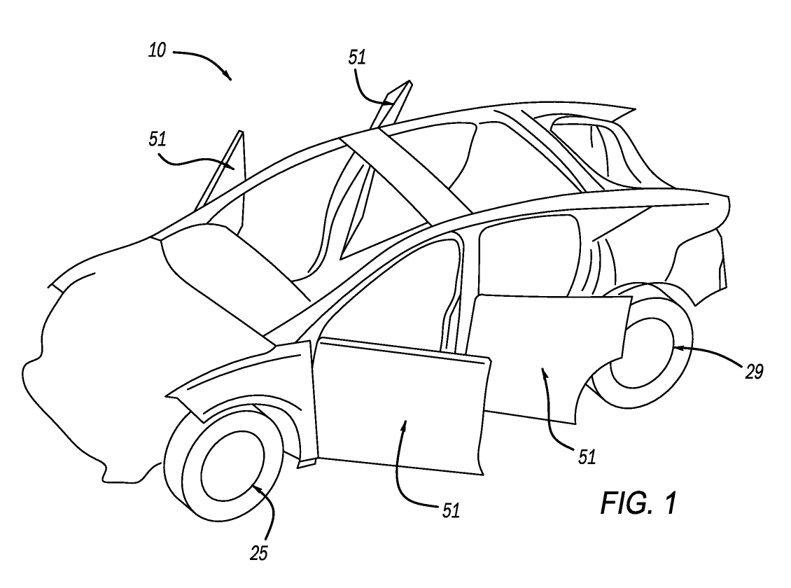

With reference to FIG. 1, a vehicle 10 such as an electric vehicle is provided. In the example provided, the electric vehicle is a battery electric vehicle (BEV). In other examples, the electric vehicle may be a hybrid electric vehicle (HEV), a plug-in electric vehicle (PHEV), or a fuel cell vehicle. In still other examples, the vehicle 10 may be an internal combustion engine driven vehicle.

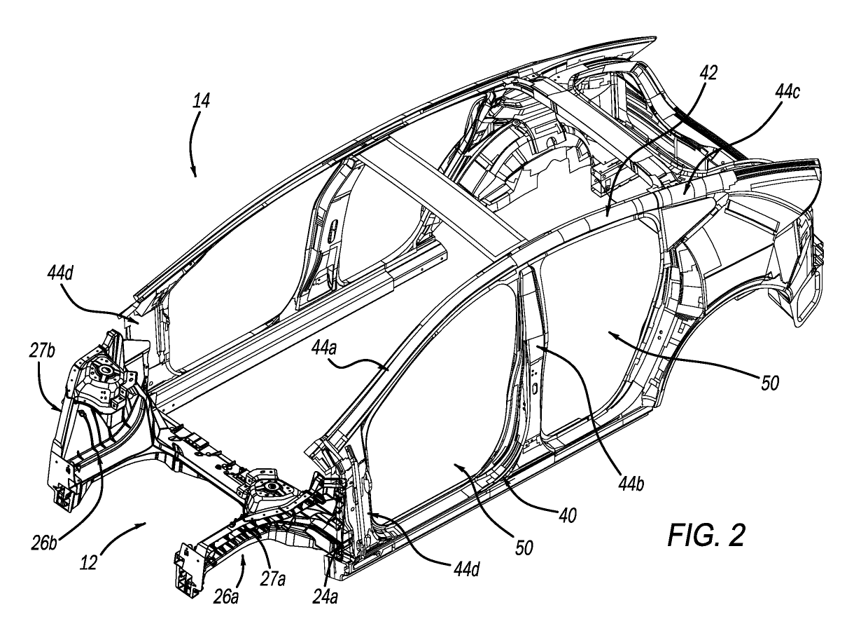

With additional reference to FIG. 2, the vehicle 10 includes a front vehicle structure 12, a side vehicle structure 14, and a floor and battery assembly (not shown). The front vehicle structure 12 is located closer toward a front of the vehicle 10 than the side vehicle structure 14 and is coupled to the side vehicle structure 14 as described in more detail below. In one example, the front vehicle structure 12 is manufactured using a plurality of stamped parts that are secured to each other, e.g., via welding, adhesive, or fasteners. In another example, the front vehicle structure 12 is manufactured using a casting process. The front vehicle structure 12 includes, inter alia, a front dash cross member (not shown), a pair of cowl sides 24a, 24b, a pair of inner rails 26a, 26b, a pair of upper rails 27a, 27b, and a bumper (not shown). The front dash cross member extends in the transverse direction of the front vehicle structure 12 and connects to the inner rails 26a, 26b and a front subframe (not shown). Each inner rail 26a, 26b extends from a lower portion of a respective cowl side 24a, 24b to the bumper. Each inner rail 26a, 26b can also be arcuate and extend around a front wheel 25 (FIG. 1) of the vehicle 10 and form a portion of a respective front wheel well. The upper rails 27a, 27b are positioned above the pair of inner rails 26a, 26b and extend from an upper portion of a respective cowl side 24a, 24b toward a front of the vehicle 10. The bumper extends in a transverse direction relative to a longitudinal direction of the vehicle 10 and is secured to front ends of the pair of inner rails 26a, 26b.

The front subframe (not shown) is positioned below the front vehicle structure 12 and is secured to the pair of inner rails 26a, 26b of the front vehicle structure 12. The front subframe may support one or more components of the vehicle 10 such as a front motor (not shown) and front suspension components (not shown) that may also be coupled to the front vehicle structure 12. The front motor is powered by a battery pack (not shown) of the floor and battery assembly (not shown) to selectively drive a set of front wheels 25 (FIG. 1; only one wheel shown in the figure). The front suspension components provide a smooth ride by absorbing energy from various road bumps while driving. The front suspension components may include upper and lower control arms, springs, shock absorbers, struts, and ball joints, for example. It should also be understood that other components may be coupled to the front vehicle structure 12 such as an instrument panel structure 35 and electronics (e.g., inverters, AC-DC converter, and DC-DC converter).

With continued reference to FIG. 2, the side vehicle structure 14 includes rockers 40, upper side rails 42, and a plurality of pillars (e.g., a pair of front pillars 44a, a pair of middle pillars 44b, a pair of rear pillars 44c and a pair of hinge pillars 44d). The rockers 40 extend lengthwise in a longitudinal direction of the vehicle 10 and may be configured to mount the battery pack (not shown) to the side vehicle structure 14. Each rocker 40 is made of a metal material such as aluminum, for example, and may be secured to a respective side of the battery pack using fasteners, adhesives, welding, or any other suitable attachment means, for example.

Each upper side rail 42 is positioned at a side of the side vehicle structure 14 and extends along the longitudinal direction of the vehicle 10. Each upper side rail 42 includes one or more structural members extending along the longitudinal direction of the vehicle 10. Each front pillar 44a extends in the longitudinal direction of the vehicle 10 from a respective upper side rail 42 to a respective hinge pillar 44d. Each middle pillar 44b extends in a vertical direction from a respective upper side rail 42 to a respective rocker 40. Each rear pillar 44c extends toward a rear of the vehicle 10 from an end of a respective upper side rail 42. The front pillars 44a, the middle pillars 44b, the hinge pillars 44d, the rockers 40 and the upper side rails 42 cooperate to define door openings 50 in the side vehicle structure 14. Doors 51 (FIG. 1) are rotatably coupled to the side vehicle structure 14 and/or the front vehicle structure 12 and rotatable between a closed position in which the doors 51 are disposed within the door openings 50 and an open position in which the doors 51 are removed from the door openings 50.

Each hinge pillar 44d extends in a vertical direction from an end of a respective front pillar 44a to an end of a respective rocker 40. In the example illustrated, one hinge pillar 44d is secured to the cowl side 24a of the front vehicle structure 12 and one hinge pillar 44d is secured to the cowl side 24b of the front vehicle structure 12. In this way, an intermediate vehicle structure is formed.

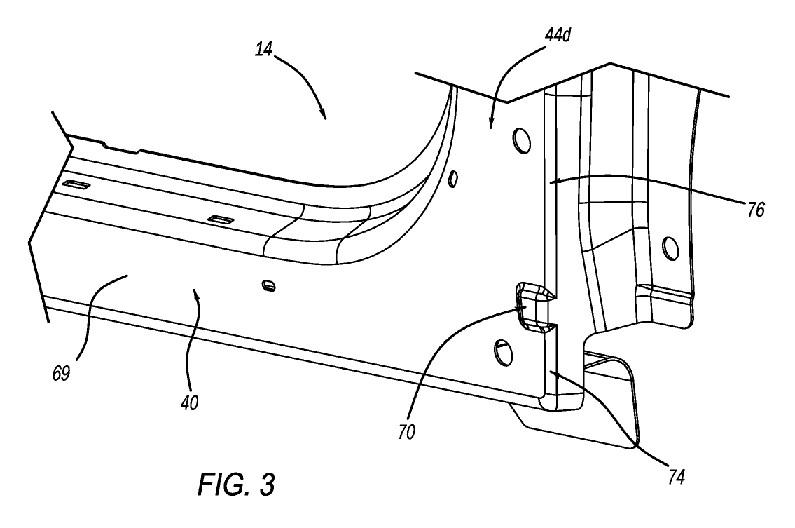

With reference to FIG. 3, the side vehicle structure 14 includes a bump feature or boss 70 coupled thereto. As will be described in more detail below, the bump features 70 protrude laterally and are configured to contact the front vehicle structure 12 during assembly of the vehicle 10. In this way, the bump features 70 facilitate coupling of the front and rear vehicle structures 12, 14 while inhibiting inadvertent wiping of sealant material as described in more detail below. Although the present disclosure includes the bump features 70 coupled to the side vehicle structure 14, in some forms, the bump features 70 may be coupled to the front vehicle structure 12 (e.g., cowl sides 24a, 24b) and configured to contact the side vehicle structure 14 to facilitate assembly of the vehicle 10. That is, the bump features may extend outward from the cowl sides 24a, 24b of the front vehicle structure 12 and contact the hinge pillars 44d of the side vehicle structure 14. In the example illustrated, the bump features 70 are located at or near a lower portion 74 of an inside side 69 of the hinge pillars 44d and/or rockers 40 (i.e., side facing the battery pack or a center of the vehicle 10). In some forms, the bump features 70 may be located at or near a middle portion 76 of the hinge pillars 44d or at another suitable area of the hinge pillars 44d. In the example illustrated, the bump features 70 are integrally formed with the inside of the hinge pillars 44d and/or rockers 40, and extend inward from the inside of the hinge pillars 44d and/or the rockers 40 toward each other. That is, the bump features 70 may be formed as part of the side vehicle structure 14 during the manufacturing process. In some forms, the bump features 70 may be separate components (e.g., pins) that are removably coupled to the inside of the hinge pillars 44d and/or rockers 40 to facilitate coupling of the front and rear vehicle structures 12, 14. In the example illustrated, the bump features 70 have a square shape. In some forms, the bump features 70 may a circular shape or any other suitable shape that extends inward a further distance than the hinge pillars 44d and/or the rockers 40.

A rear subframe (not shown) is secured to the side vehicle structure 14 and may support one or more components of the vehicle 10 such as a rear motor (not shown) that may also be coupled to the side vehicle structure 14. The rear motor is powered by the battery pack (not shown) to selectively drive rear wheels 29 of a set of rear wheels. It should also be understood that other components may be coupled to the side vehicle structure 14 such as a vehicle floor (not shown) of the floor and battery assembly (not shown), rear suspension components (not specifically shown), and the battery pack (not shown). The rear suspension components provide a smooth ride by absorbing energy from various road bumps while driving. The rear suspension components may include upper and lower control arms, springs, shock absorbers, struts, and ball joints, for example. The battery pack may be rechargeable and may include lithium-ion batteries or any other suitable electrical power storage units. The battery pack may be disposed at and mounted to various locations of the side vehicle structure 14. In this way, the battery pack is supported by the side vehicle structure 14 and is remote from a passenger cabin (not shown) and cargo compartments (not shown) of the vehicle 10, therefore, not occupying space that would otherwise be available for passengers or cargo. One example of such battery pack is disclosed in U.S. Patent Application Number 17/980,208 titled "STRUCTURAL ASSEMBLY FOR BATTERY STRUCTURE OF ELECTRIC VEHICLE" which is commonly owned with the present application and the contents of which are incorporated herein by reference in its entirety.

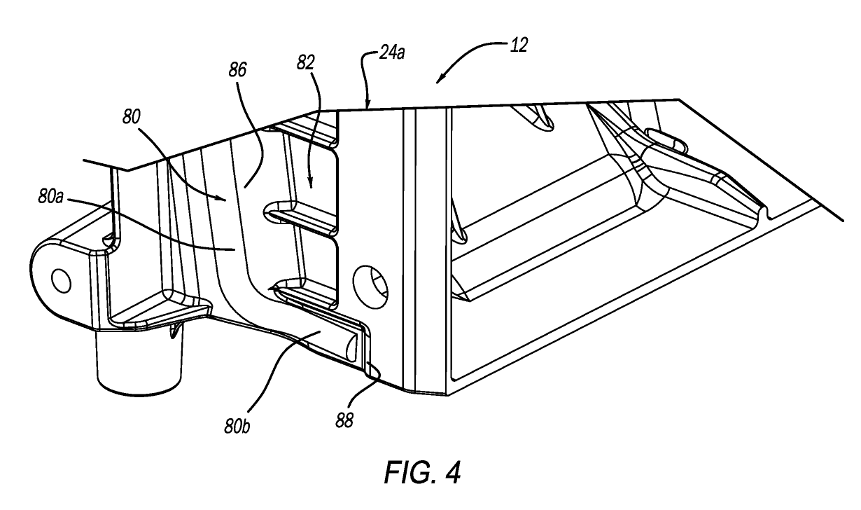

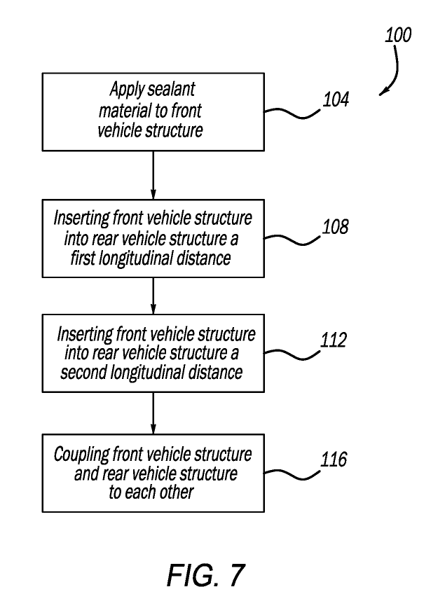

With reference to FIGS. 4, 5A-5D, 6A-6C, and 7, a method of assembling the vehicle 10 will be described in detail. At 104, sealant material 80 (e.g., silicone) is applied to the cowl side 24a of the front vehicle structure 12 and the cowl side 24b of the front vehicle structure 12 (only shown applied to the cowl side 24a of the front vehicle structure 12 in FIG. 4). In the example illustrated, the sealant material 80 is applied to a lateral surface 82 of the cowl side 24a of the front vehicle structure 12 and a lateral surface 82 of the cowl side 24b of the front vehicle structure 12. The sealant material 80 may be applied in a predetermined pattern along the lateral surfaces 82. For example, the sealant material 80 may include a vertical portion 80a extending along a first section 86 of the lateral surface 82 and a horizontal portion 80b extending along a second section 88 of the lateral surface 82. In this way, the sealant material 80 has a generally L-shape along the lateral surface 82 that extends from an uppermost end of the lateral surface 82 to a lowermost end of the lateral surface 82. In the example illustrated, the horizontal portion 80b is proximate a rear end of the lateral surface 82 and the vertical portion 80a is proximate a front end of the lateral surface 82. In another aspect of the example illustrated, the first section 86 may be chamfered and extend laterally outward a further distance than the second section 88. In some forms, both sections 86, 88 may extend laterally outward the same distance (e.g., the sections 86, 88 may be coplanar).

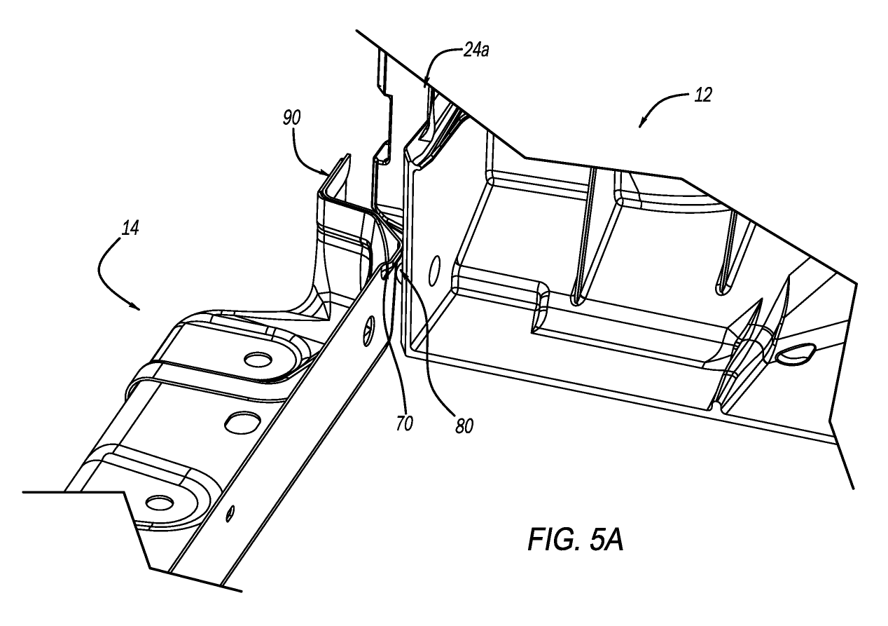

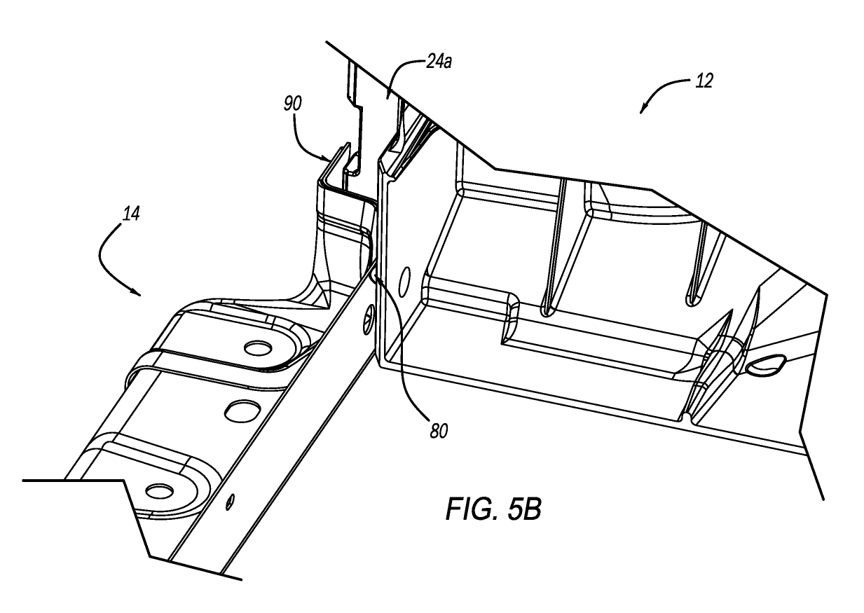

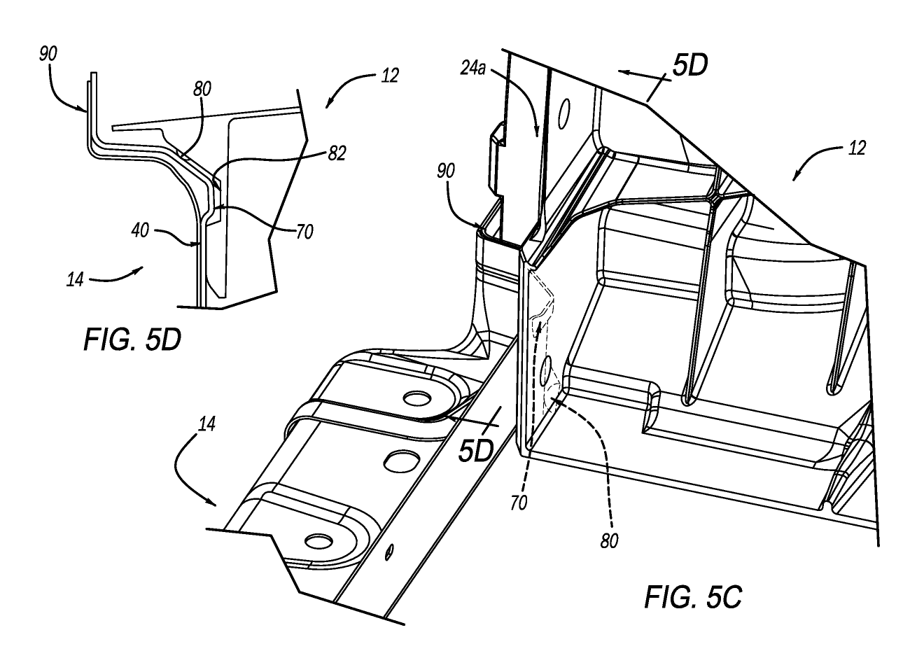

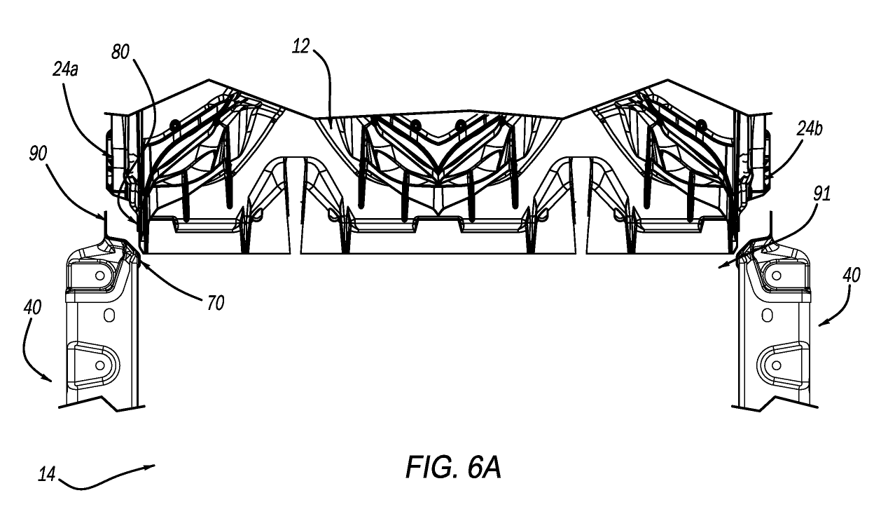

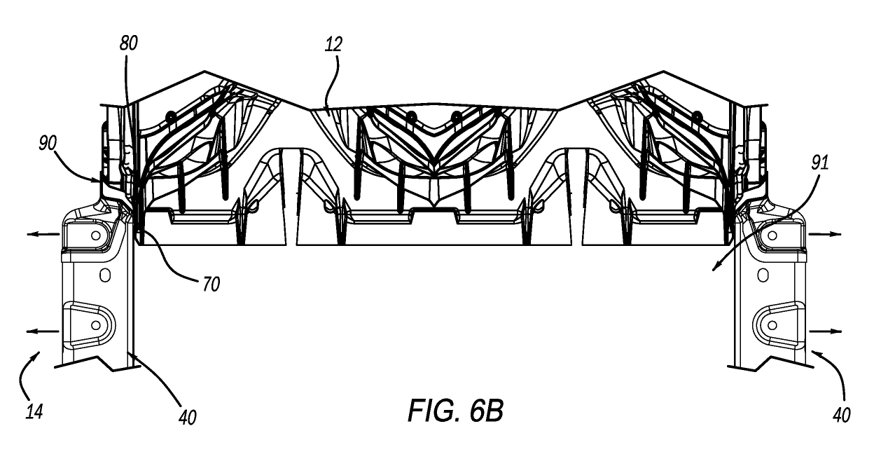

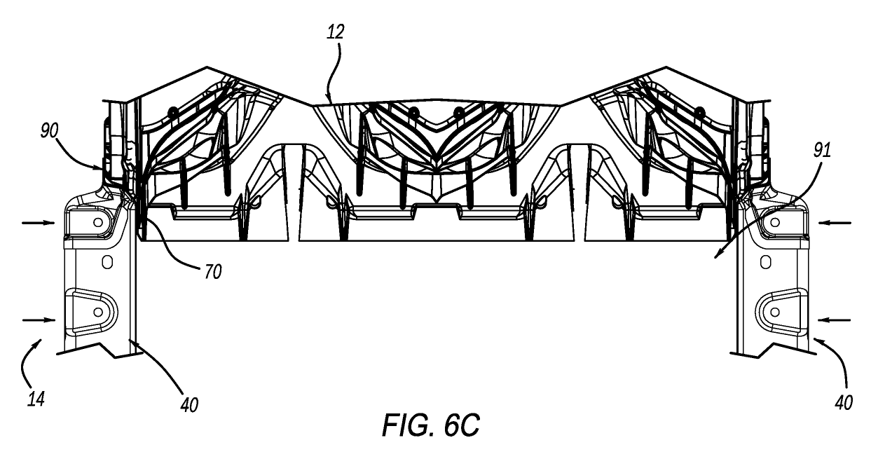

At 108, a portion of the front vehicle structure 12 is inserted into an opening 91 of the side vehicle structure 14 a first longitudinal distance such that the hinge pillars 44d (and the rockers 40) move away from each other (see arrows in FIG. 6B indicating hinge pillars 44d and rockers 40 moving laterally outward away from each other) and are spaced apart from the sealant material 80 (FIGS. 5A, 5B, 6A, and 6B). That is, the bump features 70 of the side vehicle structure 14 contact an outer portion of the lateral surfaces 82 of the front vehicle structure 12 to guide the hinge pillars 44d (and the rockers 40) laterally outward away from each other. In this way, the side vehicle structure 14 does not inadvertently wipe away the sealant material 80 applied to the front vehicle structure 12 as it is being inserted into the opening 91. It should also be understood that flanges 94 of the rockers 40 are located further lateral outwardly than the cowl sides 24a, 24b of the front vehicle structure 12 when the portion of the front vehicle structure 12 is inserted into the opening 91 of the side vehicle structure 14 the first distance. In this way, the flanges 94 are inhibited from contacting the sides 24a, 24b of the front vehicle structure 12 during assembly of the vehicle structures 12, 14.

At 112, the portion of the front vehicle structure 12 is inserted into the opening 91 of the side vehicle structure 14 a second longitudinal distance such that the hinge pillars 44d (and the rockers 40) move toward each other and the rockers 40 contact the sealant material 80 in a transverse direction (FIGS. 5C and 6C; i.e., the transverse direction is perpendicular to the longitudinal direction of the vehicle 10). That is, the bump features 70 of the side vehicle structure 14 are moved from the outer surface of the lateral surfaces 82 into recesses of the front vehicle structure 12 allowing the hinge pillars 44d (and the rockers 40) to move toward each other and contact the sealant material 80. This compacts the sealant material 80 and creates an adhesive bond. This also provides that the horizontal portion 80b of the sealant material 80 is between a respective bump feature 70 and a respective second section 88 of the lateral surface 82. At 116, mechanical fasteners (screws, rivets, bolts) extend through the front and rear vehicle structures 12, 14, thereby securing the front and rear vehicle structures 12, 14 to each other. The sealant material 80 is allowed to cure thereby creating a seal between the front and rear vehicle structures 12, 14.

It should be understood that, in some forms, first vehicle components (e.g., front motor, front suspensions) may be coupled to the front vehicle structure 12 and second vehicle components (e.g., rear motor, rear suspensions) may be coupled to the side vehicle structure 14 before the front and rear vehicle structures 12, 14 are secured to each other. One example of such assembling method is disclosed in U.S. Patent Application Number 18/495,075 titled "METHOD OF ASSEMBLING A VEHICLE" which is commonly owned with the present application and the contents of which are incorporated herein by reference in its entirety. In other forms, the first vehicle components may be coupled to the front vehicle structure 12 and the second vehicle components may be coupled to the side vehicle structure 14 after the front and rear vehicle structures 12, 14 are secured to each other.

The vehicle 10 of the present disclosure provides the benefit of assembling the front vehicle structure 12 and the side vehicle structure 14 together to in a way to inhibit the sealant material from being wiped from the font vehicle structure 12. In this way, sealing between the front vehicle structure 12 and the side vehicle structure 14 is facilitated. The vehicle 10 of the present disclosure also inhibits the rockers 40 of the side vehicle structure 14 from contacting outermost sides of the front vehicle structure 12 during assembly of the front and rear vehicle structures 12, 14.

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for assembling a vehicle, the method comprising:
applying a first sealant material to a first part of a first vehicle structure and applying a second sealant material to a second part of the first vehicle structure;
inserting a first portion of the first vehicle structure into an opening of a second vehicle structure a first distance such that opposing second portions of the second vehicle structure move away from each other and are spaced apart from respective first and second sealant materials; and
inserting the first portion of the first vehicle structure into the opening a second distance such that the opposing second portions move toward each other and contact the respective first and second sealant materials in a transverse direction.

2. The method of claim 1, wherein one of the first and second vehicle structures includes left and right bump features that are configured to contact the other of the first and second vehicle structures to guide the opposing second portions of the second vehicle structure away from each other when the first portion of the first vehicle structure is inserted into the opening the first distance.

3. The method of claim 2, wherein the second vehicle structure includes the left and right bump features.

4. The method of claim 3, wherein the first sealant material is between the left bump feature and the first part of the first vehicle structure when the first portion of the first vehicle structure is inserted into the opening the second distance, and wherein the second sealant material is between the right bump feature and the second part of the first vehicle structure when the first portion of the first vehicle structure is inserted into the opening the second distance.

5. The method of claim 3, wherein the opposing second portions are left and right pillars, and wherein the left bump feature is coupled to the left pillar and the right bump feature is coupled to the right pillar.

6. The method of claim 5, wherein the left bump feature is integrally formed with the left pillar and the right bump feature is integrally formed with the right pillar.

7. The method of claim 6, wherein the left bump feature extends inward from an inner surface of the left pillar and the right bump feature extends inward from an inner surface of the right pillar.

8. The method of claim 1, wherein the second vehicle structure includes a left flange and a right flange, and wherein the first vehicle structure includes a left side and a right side.

9. The method of claim 8, wherein the left flange is located outboard the left side when the first portion of the first vehicle structure is inserted into the opening the first distance, and wherein the right flange is located outboard the right side when the first portion of the first vehicle structure is inserted into the opening the first distance.

10. The method of claim 1, wherein the opposing second portions are left and right pillars, and wherein the second vehicle structure defines a left door opening and a right door opening, the left pillar partially defines the left door opening and the right pillar partially defines the right door opening.

11. The method of claim 1, wherein the first vehicle structure includes a pair of inner rails and a pair of cowl sides, and wherein each inner rail is arcuate and extends from a lower portion of a respective cowl side.

12. A method for assembling a vehicle, the method comprising:
applying a first sealant material to a first part of a first vehicle structure and applying a second sealant material to a second part of the first vehicle structure;
inserting a portion of the first vehicle structure into an opening of a second vehicle structure a first longitudinal distance such that left and right pillars of the second vehicle structure move away from each other and are spaced part from respective first and second sealant materials; and
inserting the portion of the first vehicle structure into the opening a second longitudinal distance such that the left and right pillars move toward each other and contact the respective first and second sealant materials in a transverse direction,
wherein one of the first and second vehicle structures includes left and right bump features that are configured to contact the other of the first and second vehicle structures to guide the left and right pillars of the second vehicle structure away from each other when the portion of the first vehicle structure is inserted into the opening the first longitudinal distance,
wherein the second vehicle structure defines a left door opening and a right door opening, and wherein the left pillar partially defines the left door opening and the right pillar partially defines the right door opening.

13. The method of claim 12, wherein the second vehicle structure includes the left and right bump features.

14. The method of claim 13, wherein the first sealant material is between the left bump feature and the first part of the first vehicle structure when the portion of the first vehicle structure is inserted into the opening the second longitudinal distance, and wherein the second sealant material is between the right bump feature and the second part of the first vehicle structure when the portion of the first vehicle structure is inserted into the opening the second longitudinal distance.

15. The method of claim 13, wherein the left bump feature is coupled to the left pillar and the right bump feature is coupled to the right pillar.

16. The method of claim 13, wherein the left bump feature is integrally formed with the left pillar and the right bump feature is integrally formed with the right pillar.

17. The method of claim 16, wherein the left bump feature extends inward from an inner surface of the left pillar and the right bump feature extends inward from an inner surface of the right pillar.

18. The method of claim 12, wherein the second vehicle structure includes a left flange and a right flange, and wherein the first vehicle structure includes a left side and a right side.

19. The method of claim 18, wherein the left flange is located outboard the left side when the portion of the first vehicle structure is inserted into the opening the first longitudinal distance, and wherein the right flange is located outboard the right side when the portion of the first vehicle structure is inserted into the opening the first longitudinal distance.

20. A vehicle comprising:
a first vehicle structure;
a second vehicle structure configured to be coupled to the first vehicle structure, the second vehicle structure including a left pillar and a right pillar; and
first and second sealant material, the first sealant material applied to a first part of the first vehicle structure, the second sealant material applied to a second part of the first vehicle structure,
wherein one of the first and second vehicle structures includes left and right bump features that are configured to contact the other of the first and second vehicle structures to guide the left pillar and the right pillar of the second vehicle structure away from each other when a portion of the first vehicle structure is inserted into an opening of the second vehicle structure a first distance, the left and right bump features are configured to move toward each other and contact respective first and second sealant materials in a transverse direction when the portion of the first vehicle structure is inserted into the opening a second distance.
